(19) United States
(12) Patent Application Publication
(10) Pub. No.: US 2001/0021602 A1
(43) Pub. Date: Sep. 13, 2001

(54) Connector for a cable and kit for assembling the same

(75) Inventor: Albertus Van Zanten, DP's-Hertogenbosch (NL)

Correspondence Address: PERMAN & GREEN, 425 POST ROAD, FAIRFIELD, CT, 06430, US

(73) Assignee: Framatome Connectors International

(21) Appl. No.: 09/753,520

(22) Filed: Jan. 3, 2001

(30) Foreign Application Priority Data
Jan. 7, 2000 (NL) NL 1014036

(51) Int. Cl. H01R 13/627

(52) U.S. Cl. 439/358

(57) ABSTRACT

The invention pertains to a connector for a cable with one or more conductors and a common shielding, comprising a housing that is provided with a shielding, which is connected to the shielding of the cable, and which housing contains, in its front side, at least one terminal block of an electrically insulating material fitted with one or more terminals that are connected to respective conductors in the cable. The housing comprises a first opening through which a latch extends from within the housing for snap-fit connection of the connector to a counterpart and a second opening through which a push-button for mechanically operating the latch is accessible, which push-button abuts the edge of the second opening and wherein at least the surface of the push-button is made of an electrically conductive material.

The invention pertains to a connector for a cable with one or more conductors and a common shielding, comprising a housing that is provided with a shielding, which is connected to the shielding of the cable, and which housing contains, in its front side (i.e. the side which, upon connection to a counterpart, faces that counterpart), at least one terminal block of an electrically insulating material fitted with one or more terminals that are connected to respective conductors in the cable.

Such connectors are known from U.S. Pat. No. 5,096,436 and are, for instance, used to provide a connection between a cable and a printed circuit board of, for instance, a telephone exchange device or the like. Usually a large number of such cable connectors are connected to a single electronic device, often in (long) rows with a small pitch between the individual connectors. Further, in many modern applications it is important that the connection that is established is mechanically secure and provides EMI shielding so as to improve signal integrity.

The invention aims to provide a connector for a cable of the above-mentioned type, which is compact and preferably front mountable and which allows establishing a mechanically secure and EMI shielded connection.

To this end, the connector of the present invention is characterized in that the housing comprises a first opening, preferably near its front side, through which a latch extends from within the housing for snap-fit connection of the connector to a counterpart (for instance a header if the connector is a receptacle and vice versa) and a second opening through which a push-button for mechanically operating (or unlocking) the latch is accessible, which push-button abuts the edge of the second opening and wherein at least the surface of the push-button is made of an electrically conducting material.

Thus, the connector can be firmly connected to a counterpart by means of the latch and detrimental consequences of the presence of a latch are avoided. Because the latch and the push-button are placed substantially within the housing, the connector can be made relatively compact. Further, since the push-button is made of an electrically conductive material or provided with an electrically conductive coating, the integrity of EMI shielding is not affected by the presence of the pushbutton.

In a very efficient embodiment of the present invention the latch and the push-button are part of the same resilient blade or leaf spring placed within the housing, thus enabling direct operation of the latch by means of the push-button.

It is further preferred that the connector comprises a latch in each of two opposite walls of the connector. In that case the latches and push-button or buttons can be made from the same metal sheet or strip.

The invention also pertains to a kit for assembling the above-described connectors.

The invention will be further explained with reference to the drawings in which various embodiments of the connector according to the present invention are shown.

FIG. 1 shows a first embodiment of the connector according to the present invention with a latch and a pushbutton for operating the latch on both sides of the connector.

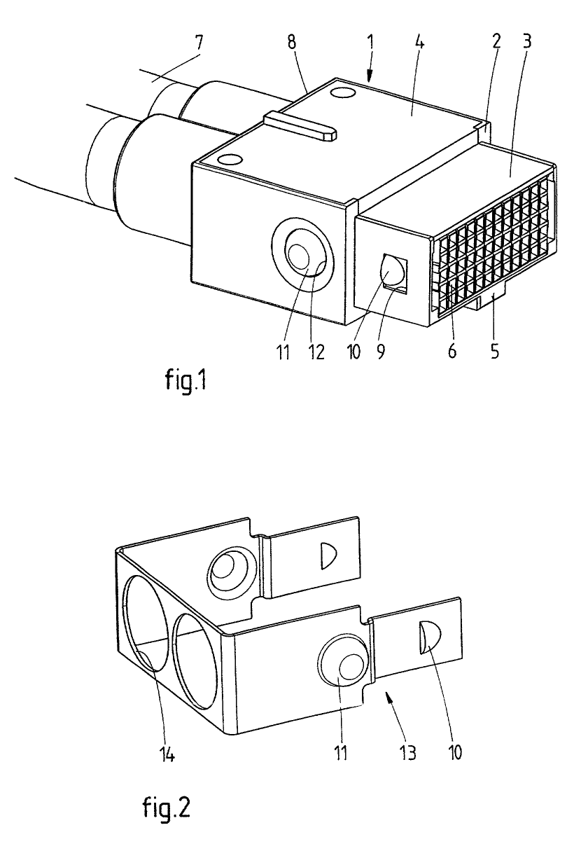

FIG. 2 shows an element that is to be placed in a housing of a connector as, for instance, shown in FIG. 1.

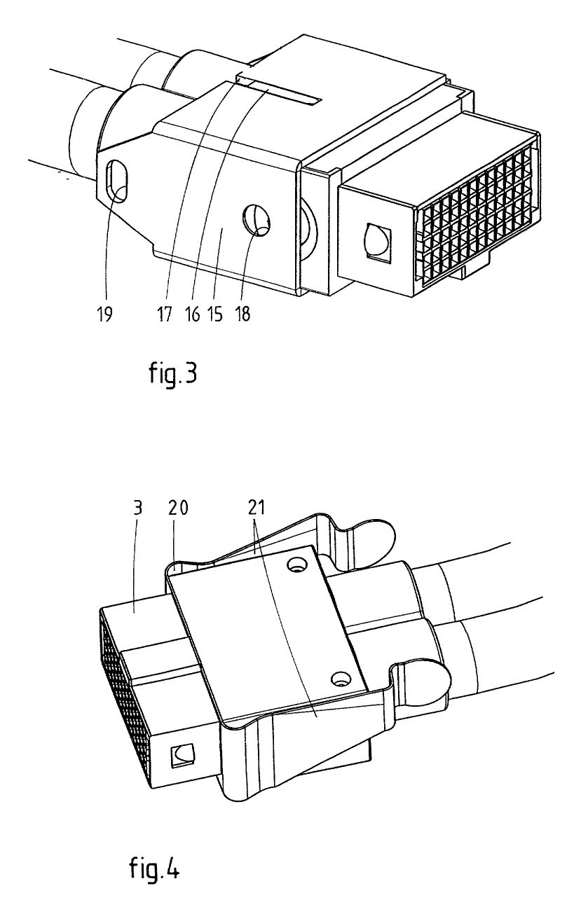

FIG. 3 shows the connector according to FIG. 1 provided with an additional sleeve.

FIG. 4 shows the connector according to FIG. 1 comprising extension means for operating the push-buttons.

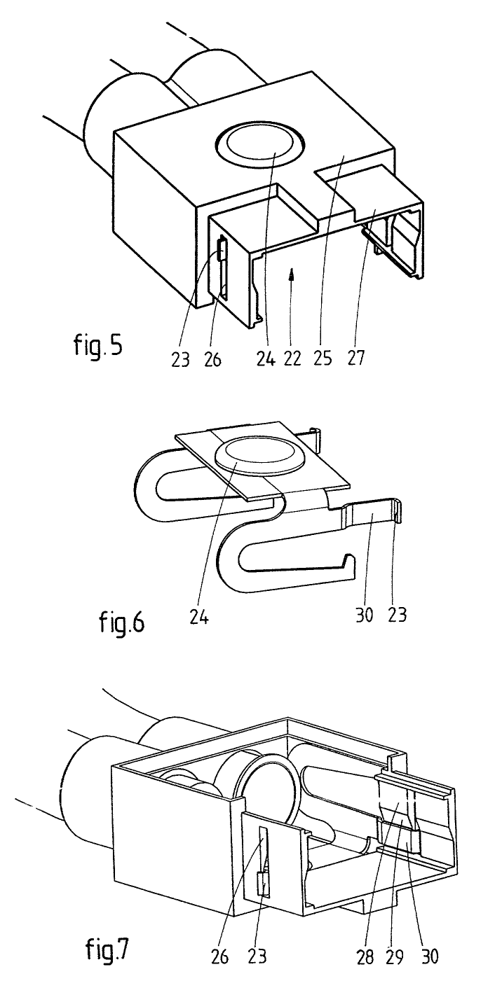

FIG. 5 shows a top view of a dissembled specimen of a second embodiment according to the present invention.

FIG. 6 shows an element comprising two latches and a single push-button for operating the same, said element being intended for use in the connector shown in FIG. 5.

FIG. 7 shows the bottom side of the connector according to FIG. 5.

FIG. 1 shows a connector 1 comprising a housing 2, which is made of a plastic material, such as nylon 66 or a liquid-crystalline polymer, by means of injection-moulding. The front side 3 of the housing 2, i.e. the side of the housing 2 that is to be connected to a counterpart, has smaller dimensions than the main body 4 of the housing 2 so as to facilitate connection to a counterpart. If the connector 1 is a so-called receptacle, its counterpart will usually be a header and vice versa. The counterpart may, for instance, be connected to a cable or a printed circuit board or the like and is preferably mounted on the other side of a front panel or support panel. Such a front panel or support panel comprises openings with roughly the same dimensions as the front side 3 of the housing 2 and, further, a groove for accommodating the alignment tongue 5, which is also part of the said front side 3.

The housing 2 is provided with EMI shielding (not shown) on its outer surface. EMI shielding may, for example, consist of an electrically conductive metal coating. Such coatings are known to the person skilled in the art, and may, for instance, comprise a copper layer with a thickness of say 1-2 μm on which a nickel or aluminium layer of say 2-3 μm has been deposited. If the housing 2 is made of an electrically conductive material, for instance a metal, such as aluminium, a separate EMI shielding will normally not be required.

The front side 3 comprises one or more terminal blocks 6 of an insulating material, which, in this example, together provide 12×5 positions and comprise a corresponding number of contact elements or terminals placed inside the said blocks 6. The said terminals are connected to conductors comprised in cables 7 on the rear side 8 of the housing 2. The EMI shielding of the housing 2 is electrically connected to the shielding of the cables 7.

The front side 3 further comprises a first opening 9 and a resiliently mounted latch 10 on two opposite sides of the housing 2. The latches 10 allow snap fit connection of the connector 1 to a front panel or support panel. The latches 10 are mechanically operated through push-buttons 11 which extend through second openings 12 on either side of the housing 2. Thus, the latches 10 can be retracted by pushing the push-buttons 11 inwardly with respect to the housing 2.

As is shown in FIG. 2, the latches 10 and pushbuttons 11 can be provided on a single element 13 that is manufactured of a strip of a resilient, electrically conductive material, such as spring steel, e.g. by stamping and bending. In such an embodiment, the latches 10 and the push-buttons 11 are part of the same resilient blade. The said element further comprises two passages 14 for lettings through the cables 7 once the connector 1 is assembled. Since the push-buttons 11 are made of an electrically conductive material and abut the edges of the second openings 12, the integrity of the EMI shielding is not affected by the presence of the said second openings 12.

It is generally preferred that at least the outer surface of the latches is electrically conductive and electrically connected to the EMI shielding. Thus, the connector can be electrically connected to the grounding of a counterpart by means of contact with the latches.

FIG. 3 shows an embodiment that is suitable for use with devices which have a large number of connectors 1 connected to them. In such devices, the pitch between the individual connectors is a usually very small and, accordingly, it may occur that the push-buttons 11 cannot be reached without additional means. A preferred example of such means is a sleeve 15 that fits snugly around the main body 4 of the housing 2 and that can slide backwards and forwards.

The forward movement is restricted by the front panel of the device to which the connector 1 is attached, whereas the backwards movement is restricted by an elongated stop 16 which fits into a slit 17 in the sleeve 15. The sleeve 15 comprises two openings 18 for accommodating the push-buttons 11 when the connector 1 is connected to an electronic device.

In this forward position, the opening 18 accommodate the tops of the push-buttons 11. If the sleeve 15 is pulled backwards, for instance by means of a cord attached to the fastening hole or holes 19, the push-buttons 11 are pushed inwardly by means of the edge of the openings 18. Consequently, the latches 10 move inwardly and the latch or snap fit connection is undone.

FIG. 4 shows a further embodiment comprising a clip 20 comprising a rectangular opening with which it is fitted over the front side 3 of the connector 1. The clip 20 comprises two arms 21 which can be operated at or near the rear side 7 of the connector 1 by pinching the arms together, thus forcing the push-buttons 11 inwardly and releasing the latch connection.

FIG. 5-7 show a second embodiment of the connector according to the present invention. This connector 22 comprises two latches 23 which are operated by a single push-button 24. The shielded housing 25 of the connector 22 comprises two elongated openings 26, one on either side of the front side 27 of the connector 22. On the inner side of the housing, near each of these openings 26, a protrusion 28 is positioned, which comprises a bevelled section 29. When the push-button 24 is pushed inwardly the arms 30 on which the latches are mounted are being moved towards the protrusion 28. In this case, the arms 30 are made of a resilient material and provide a sufficient spring force for biasing the push-button 24 against the edge of the opening through which the push-button 24 protrudes.

It will be clear from the above embodiments that the openings in the shielding of the housing of the connector are effectively closed by means of the pushbuttons of an electrically conductive material. Further, because the push-button(s) and the latches are placed within the housing, a very compact construction can be obtained.

The invention is not restricted to the above described embodiments which can be varied in a number of ways within the scope of the claims.

1. Connector for a cable with one or more conductors and a common shielding, comprising a housing that is provided with a shielding, which is connected to the shielding of the cable, and which housing contains, in its front side, at least one terminal block of an electrically insulating material fitted with one or more terminals that are connected to respective conductors in the cable, characterized in that the housing comprises a first opening through which a latch extends from within the housing for snap-fit connection of the connector to a counterpart and a second opening through which a push-button for mechanically operating the latch is accessible, which push-button abuts the edge of the second opening and wherein at least the surface of the push-button is made of an electrically conducting material.

2. Connector according to claim 1, wherein the latch and the push-button are part of the same resilient blade placed within the housing.

3. Connector according to any one of the preceding claims, wherein the connector comprises a latch in two opposite walls of the connector.

4. Connector according to any one of the preceding claims, wherein the first opening is elongated and a protrusion comprising a bevelled section is located on the inner wall of the housing next to both the latch and the first opening with the bevelled section turned towards the latch.

5. Connector according to claim 4, wherein the connector comprises a latch in two opposite walls of the connector and a push-button in a wall perpendicular or substantially perpendicular to the said walls.

6. Connector according to any one of the preceding claims, which is provided with an element that is pivotably mounted in between the latch and the push-button and extends beyond the rear of the connector.

7. Connector according to any one of the preceding claims, wherein a sleeve is slidably mounted on or over the housing, which comprises a recess or opening for accommodating the push-button in a first position of the sleeve and for pushing the push-button inwardly by means of the edge of the opening or recess in a second position of the sleeve.

8. Connector according to claim 7, wherein the housing comprises stop for restricting rearward movement of the sleeve.

9. Kit for assembling a connector according to any one of the preceding claims, comprising a housing that is provided with a shielding, which is to be connected to the shielding of the cable, and a cavity in its front side for holding at least one terminal block of an electrically insulating material fitted with one or more contact elements that are to be connected to the conductors in the cable, a first opening through which a latch extends for snap-fit connection of the connector to a counterpart and a second opening through which a push-button for mechanically operating the latch is accessible, which abuts the edge of the second opening and wherein at least the surface of the push-button is made of an electrically conducting material.
